(19) United States
(12) Patent Application Publication
(10) Pub. No.: US 2020/0167727 A1
(43) Pub. Date: May 28, 2020

(54) Transport System, Transport Controller, and Layout of Physical Distribution

(71) Applicant: Hitachi Industrial Products, Ltd., Tokyo (JP)

(72) Inventor: Akiharu IKEDA, Tokyo (JP)

(21) Appl. No.: 16/653,262

(22) Filed: Oct. 15, 2019

(30) Foreign Application Priority Data
Nov. 26, 2018 (JP) 2018-219906

(51) Int. Cl. G06Q 10/08; G06F 17/16

(52) U.S. Cl. CPC G06Q 10/0836; G06Q 10/087; G06F 17/16; G06Q 10/0833; G06Q 10/0832

(57) ABSTRACT

A transport system includes: a storage container that stores therein an item before the item is subjected to an order picking operation; a sorting container that stores therein an item after the item is subjected to the order picking operation; a transport robot that holds the storage container or the sorting container and transports the storage container or the sorting container in the holding state; and a transport controller configured to transmit, to the transport robot, an instruction that the storage container or the sorting container be transported to a picking area in which an item for which an order is placed from a customer is picked from the storage container and is transferred to the sorting container, and, in determining which customer for an ordered item be allocated to which sorting container, allocate one customer to one sorting container.

### CROSS REFERENCE TO RELATED APPLICATION

This application claims the benefit of Japanese Patent Application No. 2018-219906 filed on Nov. 26, 2018, the disclosure of which is incorporated herein by reference.

### BACKGROUND OF THE INVENTION

### 1. Field of the Invention

The present invention relates to a transport system, a transport controller, and layout of physical distribution.

### 2. Description of the Related Art

A physical distribution center is used as one of infrastructural facilities for promptly delivering items for business transactions of customers. The physical distribution center receives an item from a manufacturer or the like and stores therein the received item temporarily. Upon receipt of an order, in the physical distribution center, an item for which an order is placed is picked, is packaged, and is shipped to a customer of interest.

The physical distribution center has an area in which a series of the above-described steps (receipt, storage, picking, packaging, and shipping) are carried out. Efficient transportation of items between different areas is thus an important management strategy for a business enterprise operating such a physical distribution center. The transportation as described above has been recently automated and mechanized and has already become further efficient in many cases. In addition to the efficient transportation of items, labor-saving of operations in dealing with items is also important.

PCT International Publication No. WO 2016/157367 (which may also be referred to as Patent Document 1 hereinafter) discloses that an operator: picks out a target item from a storage rack which has been transported close to the operator; and transfers the picked items into a sorting opening of a sorting rack which has been disposed also close to the operator. The operation is called “picking”. An opening setting system of Patent Document 1 determines a sorting opening into which an item is transferred such that an operation load of an operator is reduced. For example, a waist-high sorting opening is preferentially determined as a sorting opening to be used.

[Patent Document 1] PCT International Publication No. WO 2016/157367

### SUMMARY OF THE INVENTION

Patent Document 1 discloses an opening setting system which significantly improves efficiency in a picking operation, and is not, however, focused on improvement in efficiency of a packaging operation which is an operation performed downstream of the picking operation. Assume a case in which, for example, a customer “A” places an order for “3” units of item “X” and “1” unit of item “Y” (see FIG. 7 of Patent Document 1). The opening setting system allocates two sorting openings of a sorting rack to the customer “A”. The opening setting system provides an operator with such an instruction that “3” units of item “X” are to be put in one of the sorting openings and that “1” unit of item “Y” is to be put in the other. The sorting rack having a plurality of sorting openings is subjected to an operation as described above and is then transported to a packaging area.

An operator in the packaging area picks the items for customer “A” from a plurality of the sorting openings of the sorting rack and wraps the items into a package. The operator also picks one or more items for a customer “B” from another of a plurality of the sorting openings of the same sorting rack and wraps the items into another package. At this time, if a sorting rack and a customer correspond on a one to one basis, for example, an effort of locating items for a given customer from other sorting racks can be saved, which makes the packaging operation more efficient. Thus, the present invention has been made in an attempt to improve efficiency in both the picking operation and the packaging operation at the same time.

A transport system of the present invention includes: a storage container that stores therein an item before the item is subjected to an order picking operation; a sorting container that stores therein an item after the item is subjected to the order picking operation; a transport robot that holds the storage container or the sorting container and transports the storage container or the sorting container in the holding state; and a transport controller configured to transmit, to the transport robot, an instruction that the storage container or the sorting container be transported to a picking area in which an item for which an order is placed from a customer is picked from the storage container and is transferred to the sorting container, and, in determining which customer for an ordered item be allocated to which sorting container, allocate one customer to one sorting container.

Other features and advantages of the present invention will be described in embodiments for carrying out the present invention.

The present invention can improve efficiency in both a picking operation and a packaging operation at the same time.

### BRIEF DESCRIPTION OF THE DRAWINGS

FIG. 1 is a diagram illustrating an example of a plan view of a layout of a physical distribution center according to an embodiment of the present invention.

FIG. 2 is a diagram illustrating another example of a plan view of a layout of a physical distribution center according to the embodiment of the present invention.

FIG. 3 is a diagram illustrating a still another example of a plan view illustrating a layout of a physical distribution center according to the embodiment of the present invention.

FIG. 4 is a perspective view illustrating a layout of a physical distribution center according to the embodiment of the present invention.

FIG. 5A and FIG. 5B are each a diagram for explaining how to use a picking area according to the embodiment of the present invention.

FIG. 6 is a perspective view illustrating a rack used as both a storage rack and a sorting rack according to the embodiment of the present invention.

FIG. 7 is a side view illustrating the storage rack according to the embodiment of the present invention.

FIG. 8A is a plan view illustrating a transport vehicle according to the embodiment of the present invention. FIG. 8B is a side view illustrating a state in which the transport vehicle raises a loading base. FIG. 8C is a side view illustrating a state in which the transport vehicle lowers the loading base.

FIG. 9 is a diagram for explaining a configuration of a transport controller according to the embodiment of the present invention.

FIG. 10 is a diagram for explaining area information according to the embodiment of the present invention.

FIG. 11 is a diagram for explaining storage rack information according to the embodiment of the present invention.

FIG. 12 is a diagram for explaining sorting rack information according to the embodiment of the present invention.

FIG. 13 is a diagram for explaining transport vehicle information according to the embodiment of the present invention.

FIG. 14 is a diagram for explaining picking area information according to the embodiment of the present invention.

FIG. 15 is a diagram for explaining item information according to the embodiment of the present invention.

FIG. 16 is a diagram for explaining order information according to the embodiment of the present invention.

FIG. 17 is a diagram for explaining instruction information according to the embodiment of the present invention.

FIG. 18 is a diagram for explaining an attribute value and an attribute centroid according to the embodiment of the present invention.

FIG. 19 is a flowchart of steps of a processing procedure according to the embodiment of the present invention.

FIG. 20 is a flowchart of steps of a processing procedure according to a variation of the present invention.

### DETAILED DESCRIPTION OF THE EMBODIMENTS

An embodiment for carrying out the present invention (which is to be hereinafter referred to as “this embodiment”) is described in detail with reference to related drawings. This embodiment assumes an example in which a physical distribution center receives an item from a manufacturer or the like; and, in order to ship the item pursuant to an order from a customer, the item is picked and packaged. The present invention can also be applied to a case in which, for example, a manufacturer or the like stores or manages parts or products in-house. The “item” used in this embodiment is a term that encompasses commodity subject to a transaction, products, parts, and the like.

### [Layout of Physical Distribution Center]

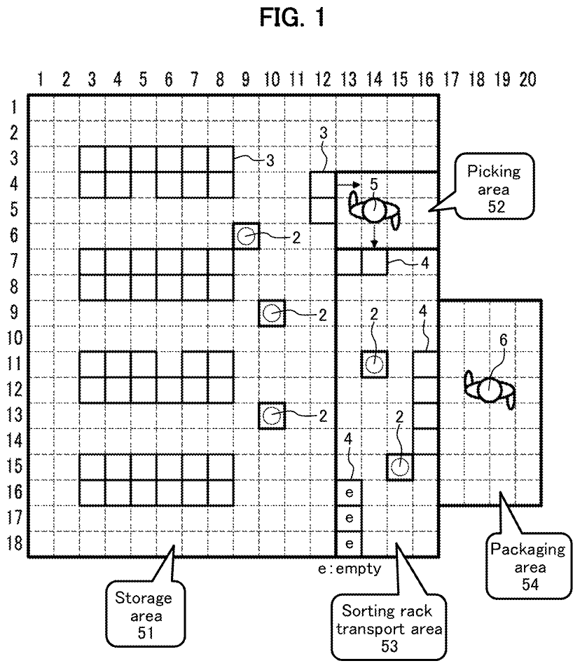

FIG. 1 is an example of a plan view of a physical distribution center. A floor surface of the physical distribution center includes a storage area 51, a picking area 52, a sorting rack transport area 53, and a packaging area 54. A boundary line (a solid line in the figure) is drawn between the areas. The boundary line does not represent a real wall, fence, or the like. There is no limitation in traffic of people or the like across the areas.

The storage area 51 is an area for storing an item. A plurality of storage racks 3 are disposed in the storage area 51. The storage racks 3 arranged in two rows and six columns form an “island”. The islands are arranged in four rows and one column in the storage area 51. A plurality of transport vehicles 2 are present in the storage area 51. The transport vehicle 2 can lift up and transport the storage rack 3 (to be detailed hereinafter). The storage area 51 is situated next to the picking area 52. In the storage area 51, there are some storage racks 3 disposed in a section adjoining the picking area 52.

The picking area 52 is situated next to both the storage area 51 and the sorting rack transport area 53. In the sorting rack transport area 53, there are some sorting racks 4 disposed in a section adjoining the picking area 52. A picking operator 5 (or a robot) picks out an ordered item from the storage rack 3 and transfers the picked item into the sorting rack 4. Arrows directed to and from the picking operator 5 in the figure represent the above-described operation. The operation is to transfer an item based on an order and is called “picking” as described above.

The sorting rack transport area 53 is situated next to the packaging area 54. In the sorting rack transport area 53, there are some sorting racks 4 disposed in a section adjoining the packaging area 54. In other sections of the sorting rack transport area 53, there are another sorting racks 4 in each of which an item is not placed. Those sorting racks 4 in which no item is placed may also be described as “empty” or just “e” in abbreviation. A plurality of the transport vehicles 2 are present in the sorting rack transport area 53. The transport vehicle 2 can lift up and transport the sorting rack 4. Note that in this embodiment, one same rack may be used as the sorting rack 4 in some cases, and, as the storage rack 3 in others, and is differently named according to respective different functions (to be described in detail hereinafter). The transport vehicle 2 which travels in the storage area 51 is the same as the transport vehicle 2 which travels in the sorting rack transport area 53. The transport vehicle 2 may or may not travel across the storage area 51 and the sorting rack transport area 53.

The packaging area 54 is an area for packaging an item. A packaging operator 6 (or a robot) picks out an item from the sorting rack 4 and packages the picked item customer (order destination) by customer. Packaging used herein means a term that encompasses, for example, box packing, bottling, and wrapping.

The term “area” which may be used herein such as “transport the storage rack 3 (or a storage container) to area X”, “area X to which the sorting rack 4 (or a sorting container) is transported”, “transport the sorting rack 4 from area X to area Y”, and the like encompasses not only an area of interest but also a section of another area which is situated next to the area of interest. In this embodiment, unless misleading is caused, the terms “rack X in area Y is transported to area Z” may also be used for simplification, instead of the terms “rack X in area Y is transported to a section adjoining area Z, from among areas other than Y”.

Vertical grid is drawn on the floor surface of the physical distribution center. A floor marker is put on or embedded in each of squares in the grid, so as not to interfere with a travel of the transport vehicle 2. The square has a longitudinal and lateral size same as those of the storage rack 3 and the sorting rack 4. The floor marker includes a coordinate value of the abscissa and a coordinate value of the ordinate as illustrated in FIG. 1. The transport vehicle 2 reads the floor marker (to be detailed hereinafter). Thus, a square on which the transport vehicle 2 will not travel at any time (for example, the packaging area 54) may not require a floor marker put thereon or embedded therein.

### [Variation of Storage Area]

FIG. 1 illustrates an example in which the storage rack 3 is disposed in a single tier on a floor surface. However, any other layout of the storage rack 3 is possible. For example, the storage area 51 may be a so-called “automatic warehouse”. The automatic warehouse typically has three-dimensionally stacked storage racks. When one of the storage racks is transported to a picking area, the storage rack of interest is first moved to a prescribed position of the stack (for example, to a lower-right foreground position). A transport vehicle passes the prescribed position. The transport vehicle retrieves the storage rack of interest from the position and transports the storage rack to the picking area.

### [Flow of Item]

How a physical distribution center works is described in the following <1> to <5> in line with a time-series flow of an item, though explanation is partially duplicated to the described above.

<1> An item is received in an item receipt area not illustrated from a manufacturer or the like. The transport vehicle 2 transports the storage rack 3 which is currently empty, to the item receipt area. An item receipt operator (or a robot) put the item to the storage rack 3. The transport vehicle 2 transports the storage rack 3 with the item stored therein to the storage area 51.

<2> When an order of an item is received, the transport vehicle 2 transports the storage rack 3 with the ordered item stored therein, to a section adjoining the picking area 52 in the storage area 51. At the same time, another transport vehicle 2 transports another empty sorting rack 4 to a section adjoining the picking area 52 in the sorting rack transport area 53. This makes the storage rack 3 disposed along a side immediately outside of the picking area 52, and the sorting rack 4 disposed along another side.

<3> The picking operator 5 reaches the item across a boundary line, picks the item from the storage rack 3, and transfers the item into the sorting rack 4.

<4> The transport vehicle 2 transports the sorting rack 4 with the item stored therein, to the section adjoining the packaging area 54 in the sorting rack transport area 53.

<5> A packaging operator 6 reaches the item across a boundary line between the areas, retrieves the item from the sorting rack 4, and packages the picked item.

Note that what is focused on in the present invention is mainly to improve efficiency of operations in the above-described <3> and <5> and is auxiliarily to improve efficiency of transportation in the <2>.

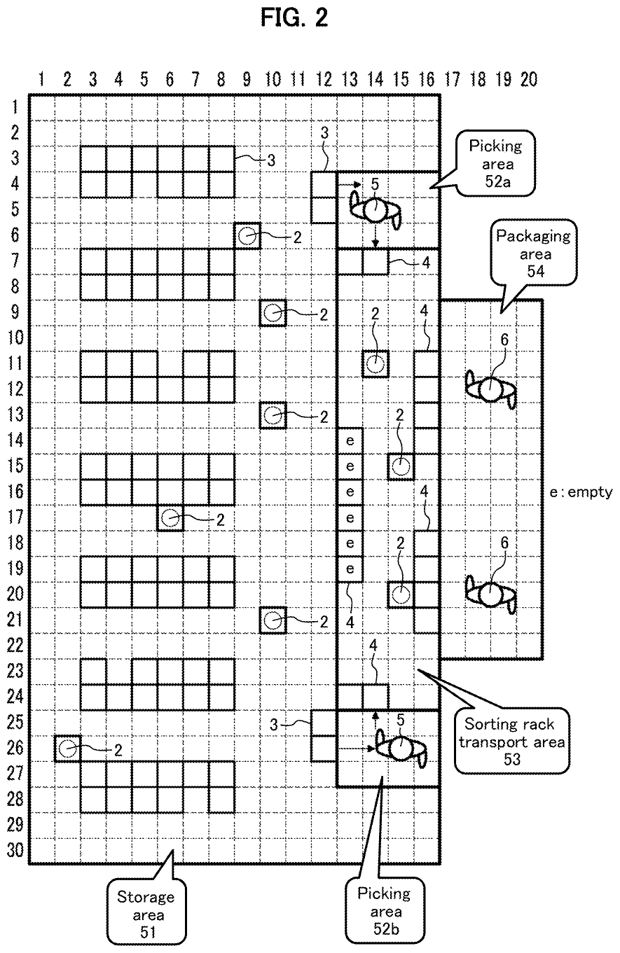

FIG. 2 illustrates another example of a plan view of a layout of a physical distribution center. In this example, there are two picking areas 52 (reference numerals 52a and 52b). In FIG. 2, the sorting rack transport area 53 is disposed between the two picking areas 52a, 52b. Accordingly, the packaging area 54 is also situated between the two picking areas 52a, 52b.

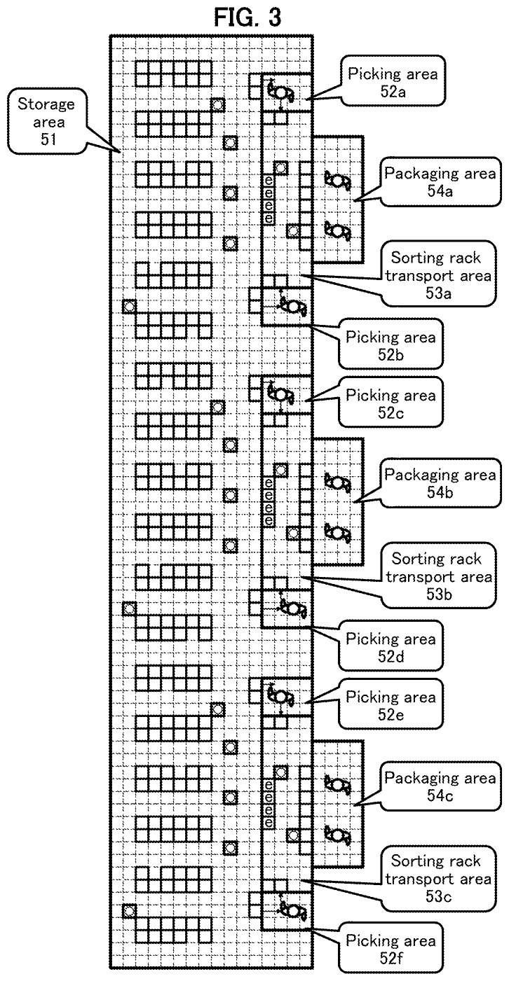

FIG. 3 illustrates a still another example of a plan view illustrating a layout of a physical distribution center. In this example, there are six picking areas 52 (reference numerals 52a to 52f); three sorting rack transport areas 53 (reference numerals 53a to 53c); and three packaging areas 54 (reference numerals 54a to 54c). In FIG. 3, the sorting rack transport area 53a is situated between the two picking areas 52a, 52b. Accordingly, the packaging area 54a is also disposed between the two picking areas 52a, 52b. Three layouts as described above are tandemly arranged in a longitudinal direction of FIG. 3.

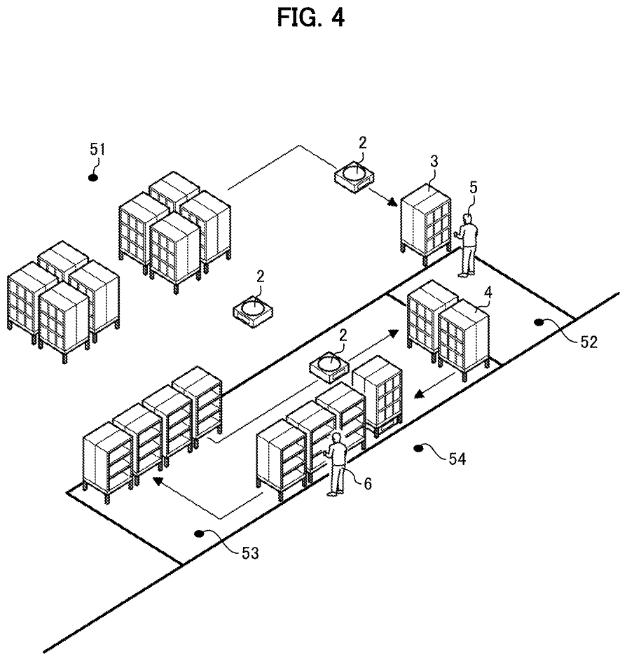

FIG. 4 is a perspective view of a layout of a physical distribution center. FIG. 4 is a birds-eye view illustrating the layout of FIG. 1 when the birds-eye view is made from ahead up above to the right. The picking operator 5 is standing on the picking area 52. The storage rack 3 is situated in front of the picking operator 5. The transport vehicle 2 has transported the storage rack 3 from the storage area 51. The storage rack 3 stores therein an ordered item. The sorting rack 4 is situated on the left side of the picking operator 5. The transport vehicle 2 has transported the sorting rack 4 which is currently empty, from the sorting rack transport area 53. The picking operator 5 picks the item from the front storage rack 3 and then transfers the picked item into the left-hand sorting rack 4.

In the sorting rack transport area 53, the transport vehicle 2 transports the sorting rack 4 into which the item has been put, from the section adjoining the picking area 52, to the section adjoining the packaging area 54. The packaging operator 6 then retrieves the item from the sorting rack 4 and packages the retrieved item. Finally, in the sorting rack transport area 53, the transport vehicle 2 transports the sorting rack 4 which has become empty, from the section adjoining the packaging area 54, to a given temporary position.

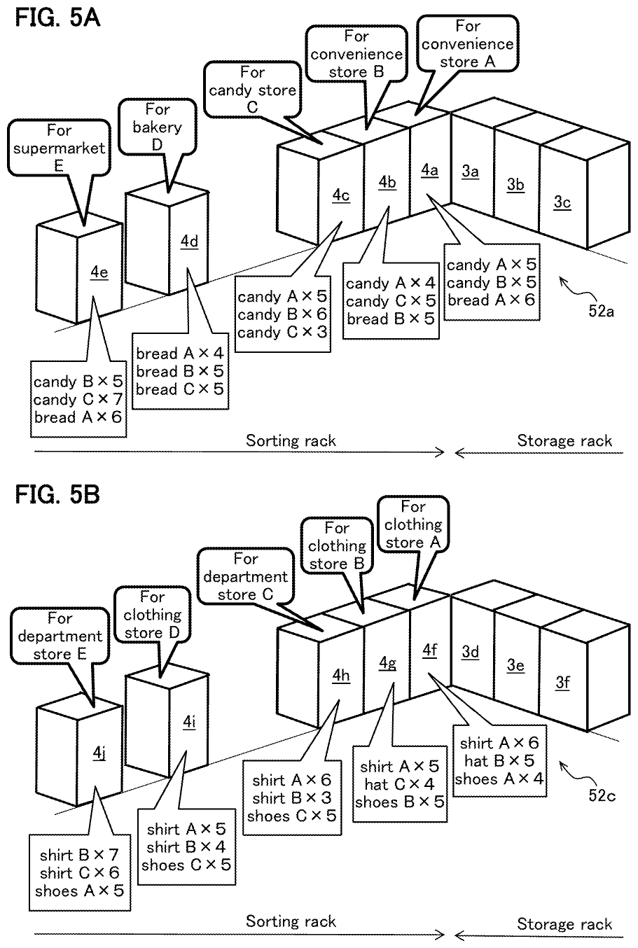

FIG. 5A and FIG. 5B are each a diagram for explaining how to use the picking area 52. FIG. 5A is a perspective view illustrating the picking area 52a (FIG. 3). Storage racks 3a to 3c are disposed on the right side of a given corner of the picking area 52a. Though not illustrated in FIG. 5A, each of the storage racks 3a to 3c stores therein an ordered item and has an opening surface which faces the picking operator 5 (the same is applied to FIG. 5B to be described hereinafter). Though not also illustrated in FIG. 5A, the transport vehicles 2 are stopped with the respective storage racks 3a to 3c carried thereon (the same is applied to FIG. 5B to be described hereinafter). The sorting racks 4a to 4c are lined on the left side of the corner of the picking area 52a, and sorting racks 4d and 4f are coming closer to the lined sorting racks 4a to 4c.

The sorting rack 4a receives therein an item exclusively for a customer “convenience store A”. More specifically, the picking operator 5: picks such items as five pieces of “candy A”, five pieces of “candy B”, and six pieces of “bread A” from any of the storage racks 3a to 3c; and transfers the picked items into the sorting rack 4a. Similarly, the sorting rack 4b receives an item exclusively for a customer “convenience store B”. The picking operator 5: picks such items as four pieces of the “candy A”, five pieces of “candy C”, and five pieces of “bread B” from any of the storage racks 3a to 3c; and transfers the picked items into the sorting rack 4b. The same applies to each of the other sorting racks 4c to 4e.

FIG. 5B is a perspective view illustrating the picking area 52c (FIG. 3). Description herein is made by focusing on the picking area 52c as an example. This is because positional relationship of the picking area 52c with respect to the storage area 51d and the packaging area 53 in FIG. 3 is the same as that of the picking area 52a. The storage racks 3d to 3f are lined on the right side of a given corner of the picking area 52c. The sorting racks 4f to 4h are lined on the left side of the corner of the picking area 52c, and sorting racks 4i and 4j are coming closer to the lined sorting racks 4f to 4h. The sorting rack 4f receives an item exclusively for a customer “clothing store A”. More specifically, the picking operator 5: picks such items as six “shirts A”, five “hats B”, and four pairs of “shoes A” from any of the storage racks 3d to 3f; and transfers the picked items into the sorting rack 4f. The same applies to each of the other sorting racks 4g to 4j.

Further details with reference to FIG. 5A and FIG. 5B are as follows.

The items picked in the picking area 52a (FIG. 5A) are all groceries, though vary in kind.

In operations for the convenience store A, the picking operator 5 firstly picks five pieces of the “candy A” from the storage rack 3a and transfers the picked items into the sorting rack 4a. The picking operator 5 may move back and forth between the storage rack 3a and the sorting rack 4a any appropriate number of times (hereinafter the same). The picking operator 5 then picks five pieces of the “candy B” from the storage rack 3b and transfers the picked items into the sorting rack 4a. The picking operator 5 further picks six pieces of the “bread A” from the storage rack 3c and transfers the picked items into the sorting rack 4a. Above description is made assuming that candy A, candy B, and bread A are separately stored in the three different storage racks 3a to 3c. The three items may be, however, stored in the same storage rack 3 (The same applies to the examples to be described hereinafter).

Though not illustrated in the figures, the sorting rack 4a in which the items have already been transferred is transported to the packaging area 54 by the transport vehicle 2. The currently-empty sorting rack 4b is then moved rightward to fill a space for the sorting rack 4a.

In operations for the convenience store B, the picking operator 5 firstly picks four pieces of the “candy A” from the storage rack 3a, and transfers the picked items into the sorting rack 4b. The picking operator 5 then picks five pieces of the “candy C” from the storage rack 3b and transfers the picked items into the sorting rack 4b. The picking operator 5 further picks five pieces of the “bread B” from the storage rack 3c and transfers the picked items into the sorting rack 4b.

The same applies to operations for other customers (candy store C, and the like).

The items picked in the picking area 52c (FIG. 5B) are all clothes, though vary in kind.

In operations for the clothing store A, the picking operator 5 (who is different from the picking operator 5 described with reference to FIG. 5A) firstly picks six “shirts A” from the storage rack 3d, and transfers the picked items into the sorting rack 4f. The picking operator 5 then picks five “hats B” from the storage rack 3e and transfers the picked items into the sorting rack 4f. The picking operator 5 further picks four pairs of the “shoes A” from the storage rack 3f and transfers the picked items into the sorting rack 4f.

The same applies to operations for other customers (a clothing store B and the like).

### COMPARATIVE EXAMPLE 1

A comparative example regarding FIG. 5A and FIG. 5B is assumed in which the sorting rack 4 does not correspond one-to-one with a customer. The comparative example has the following disadvantages.

In some cases, for example, some items for a plurality of customers are transferred to one sorting rack 4. As a result, in the downstream packaging area 54, the packaging operator 6 has to repeatedly perform such an operation of selectively picking an item for a specific customer from the one sorting rack 4, while carefully avoiding picking out an item or items for the other customers.

In another cases, for example, items for one customer are separately transferred to a plurality of the sorting racks 4. This makes a movement line of the packaging operator 6 longer.

### COMPARATIVE EXAMPLE 2

Another comparative example regarding FIG. 5A and FIG. 5B is assumed in which only one picking area 52 is present, or, even though a plurality of the picking areas 52 are present, the picking areas 52 are not differently used depending on groups divided by ordered items of similar kinds. The comparative example has the following disadvantages.

For example, the sorting rack 4a for the convenience store A, the sorting rack 4f for the clothing store A, the sorting rack 4b for the convenience store B, the sorting rack 4g for the clothing store B, and the like may be lined in the same picking area 52. This drastically increases the number of kinds of items to be picked in the picking area 52, and also increases the number of the storage racks 3 transported to the picking area 52. In many cases, items delivered from one manufacturer is stored in the same storage rack 3. It is known as a rule of thumb that the larger the number of kinds of items to be picked such as groceries, clothes, and the like, the larger the number of the storage racks 3 transported to the picking area 52.

As a result, the number of the lined storage racks 3 becomes larger, and the movement line of the picking operator 5 becomes longer.

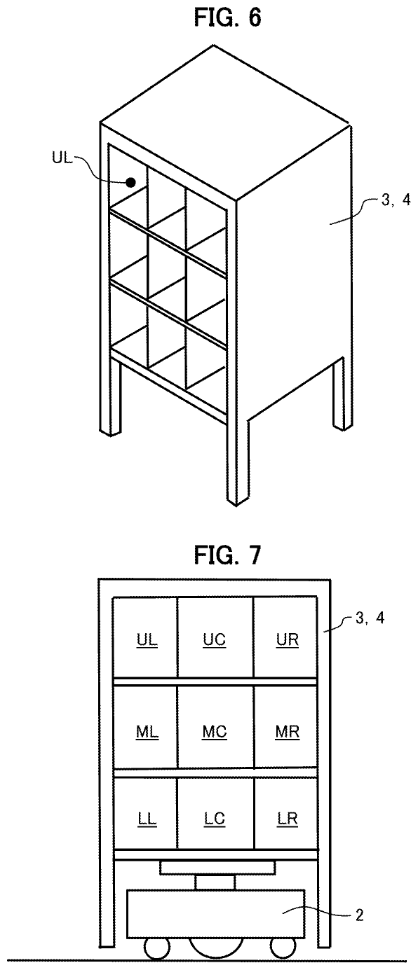

FIG. 6 is a perspective view illustrating a rack used as both the storage rack 3 and the sorting rack 4. Thus, description of the storage rack 3 made below naturally applies to the sorting rack 4. The storage rack 3 includes a square flat surface and four legs. In FIG. 6, one of the four legs cannot be seen. The storage rack 3 includes an upper shelf, a middle shelf, and a lower shelf. Each of the shelves includes a left, a center, and a right storage space. That is, the storage rack 3 has nine storage spaces. Reference characters U, M, and L are designated to the upper, the middle, and the lower shelf, respectively. Reference characters L, C, and R are designated to the left, the center, and the right storage space, respectively. In this way, for example, the storage space on the upper left shelf is designated as “UL”.

FIG. 7 is a side view illustrating the storage rack 3. The storage rack 3 has an empty space under the lower shelf. The transport vehicle 2 can get into the empty space. The transport vehicle 2 can also transport the storage rack 3 while keeping the storage rack 3 lifted up. Note that a rack may also be referred to as a “container”. The container herein includes, in addition to a shelf, a palette, a tank, a basket, and a storing box, for example.

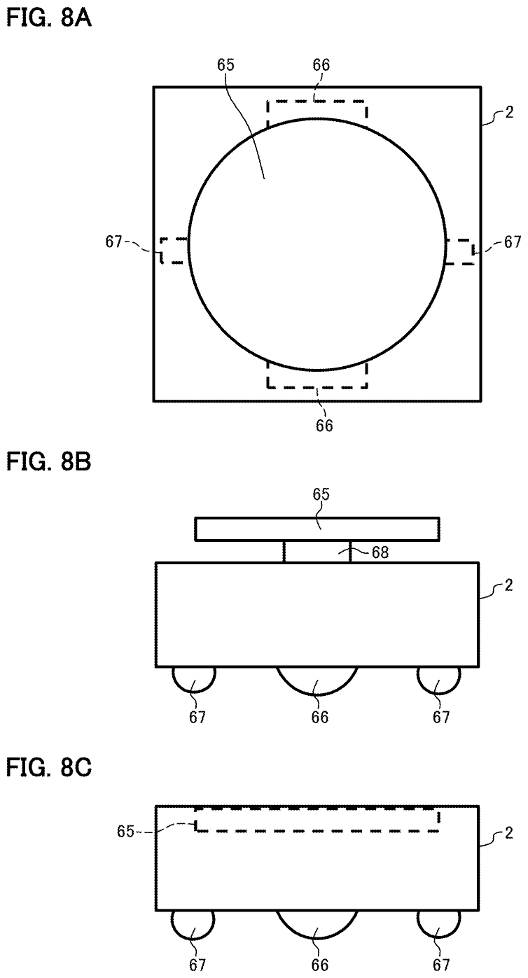

FIG. 8A is a plan view illustrating the transport vehicle 2. The transport vehicle 2 includes a square flat surface. The transport vehicle 2 also includes a disk-shaped loading base 65 disposed in the center of a top surface. The loading base 65 lifts up the storage rack 3.

FIG. 8B is a side view illustrating that the transport vehicle 2 raises the loading base 65. The transport vehicle 2 changes a height (a length) of a shaft 68, to thereby raise the loading base 65. The transport vehicle 2 has a drive wheel 66 and an auxiliary wheel 67. The drive wheel 66 is rotated by driving force of its own. The auxiliary wheel 67 has no driving force and just supports the transport vehicle 2. Any number of the drive wheels 66 and the auxiliary wheels 67 may be provided in any respective positions.

In the present invention, a container or the like may be held. The term “hold” used herein contains a meaning of “lift up”. For example, “hold” includes such operations as pulling up a container from above by a crane or the like, pulling or moving a wheeled container, or the like.

FIG. 8C is a side view illustrating that the loading base 65 of the transport vehicle 2 is lowered. At this time, the top surface of the loading base 65 is flush with a top surface of the transport vehicle 2. When the transport vehicle 2 is not in operation of transporting the storage rack 3, the loading base 65 of the transport vehicle 2 is lowered, as illustrated in FIG. 8C. A height from a floor to the top surface of the transport vehicle 2 is smaller than a height from the floor to the lower space of the storage rack 3. Thus, in the state illustrated in FIG. 8C, the transport vehicle 2 can get into and pass through the lower space of the storage rack 3. That is, the storage rack 3 as well as an island formed by the storage racks 3 do not become obstacles to the transport vehicle 2 in the state illustrated in FIG. 8C.

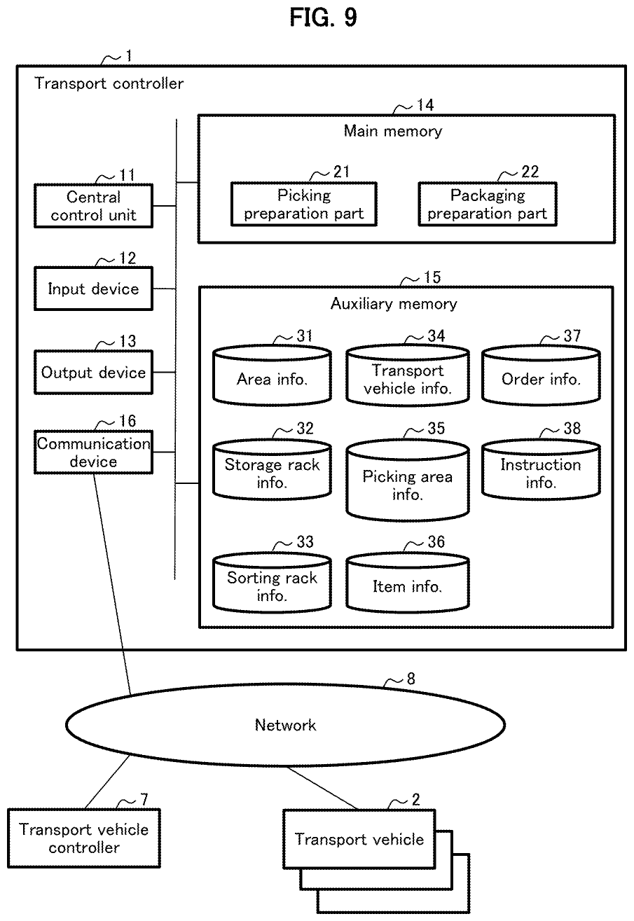

A configuration of the transport controller 1 is described with reference to FIG. 9. The transport controller 1 is a generally available computer and includes a central control unit 11, an input device 12 such as a keyboard, an output device 13 such as a display, a main memory 14, an auxiliary memory 15, and a communication device 16, all of which are communicated each other via a bus. The auxiliary memory 15 stores therein area information 31, storage rack information 32, sorting rack information 33, transport vehicle information 34, picking area information 35, item information 36, order information 37, and instruction information 38 (each of which will be described in detail hereinafter). Each of a picking preparation part 21 and a packaging preparation part 22 in the main memory 14 is a program. To simplify explanation, the parts 21 and 22 are herein assumed to directly perform their respective functions (to be detailed hereinafter). It is actually, however, the central control unit 11 that technically performs the functions of the programs by reading and loading the programs from the auxiliary memory 15 into the main memory 14.

The transport controller 1 is communicably connected to each of one or more transport vehicles 2, and a transport vehicle controller 7, via a wired or a wireless network 8 (including an in-house dedicated circuit).

In addition to the components described with reference to FIG. 8A to FIG. 8C, the transport vehicle 2 includes: an electric motor which rotates the drive wheel 66; another electric motor which adjusts a length of the shaft 68; a secondary battery which feeds power to the motors; a sensor; and an in-vehicle computer.

The sensor reads a floor marker disposed on the floor surface and thereby acquires a present position of its own. The in-vehicle computer: transmits data of various types including the present position to the transport vehicle controller 7; and receives an instruction from the transport vehicle controller 7. The in-vehicle computer: operates the electric motor based on the received instruction; adjusts a rotation direction and a rotation speed of the drive wheel 66; and also adjusts the length of the shaft 68. The sensor can also read a storage or a sorting rack ID (to be detailed hereinafter) which is attached to any appropriate position of the storage rack 3 or the sorting rack 4. The transport vehicle 2 may work not using floor markers but based on, for example, map information created according to information on surrounding environments.

The instruction described above is created by the transport controller 1. The transport vehicle controller 7 may be unitarily configured with the transport controller 1. To simplify explanation, the transport controller 1 is hereinafter assumed to have both functions of its own and of the transport vehicle controller 7. Meanwhile, the auxiliary memory 15 of the transport controller 1 may be configured separately from the transport controller 1.

The transport vehicle 2 may also be herein referred to as one form of a transport robot. How to move the transport robot includes, in addition to a wheel, a caterpillar, and a human-type leg. Note that the storage rack 3 (or a storage container), the sorting rack 4 (or a sorting container), a transport robot, and the transport controller 1 are included in the transport system.

### [Area Information]

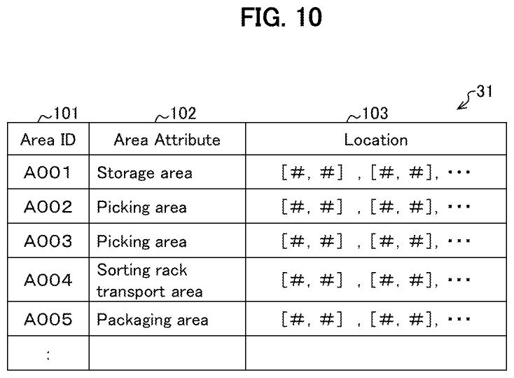

The area information 31 is described with reference to FIG. 10. The area information 31 contains the following in association with an area ID stored in a column of area ID 101: an area attribute, in a column of area attribute 102; and a location, in a column of location 103.

The area ID in the area ID column 101 is an identifier for uniquely identifying an area. The area used herein means a portion on a floor surface of a physical distribution center, and one area does not overlap with the other neighboring or surrounding areas.

The area attribute in the area attribute column 102 represents a function of the area, and is any one of “storage area”, “picking area”, “sorting rack transport area”, and “packaging area” as described above.

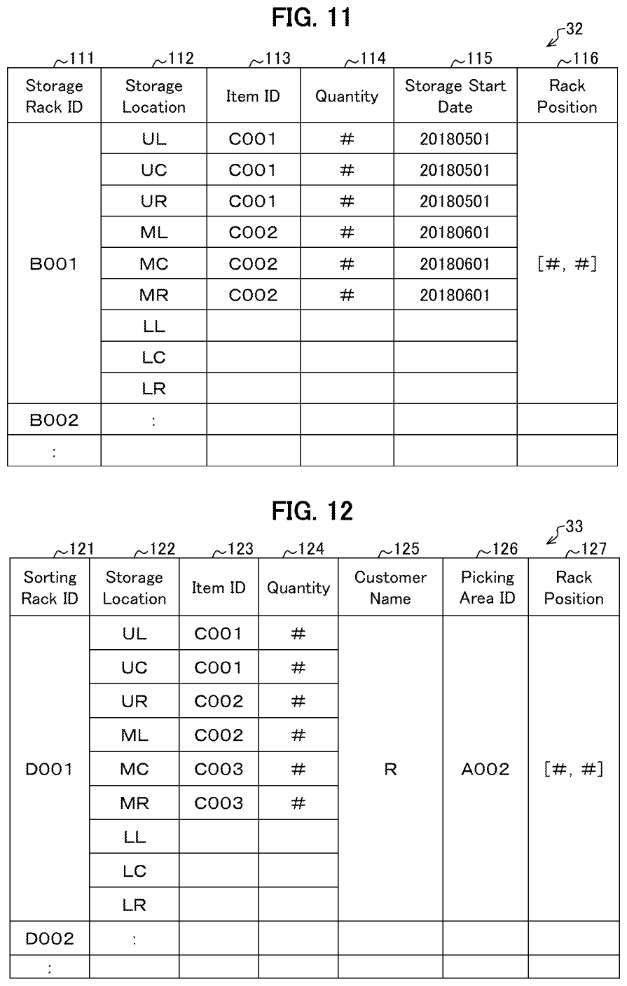

A location in the location column 103 is a combination of a coordinate value of an abscissa and a coordinate value of an ordinate as shown in FIG. 1. More specifically, the location column 103 stores therein location information for identifying each of all squares included in an area of interest. Note that “#” is any number (hereinafter the same in FIG. 11 and the like).

Each time a user of the transport controller 1 wants to update an area attribute of the physical distribution center or a boundary line drawn between adjoining areas, the input device 12 receives updated data from the user. The transport controller 1 stores the input data in auxiliary memory 15 as the area information 31.

### [Storage Rack Information]

The storage rack information 32 is described with reference to FIG. 11. The storage rack information 32 contains the following in association with a storage rack ID stored in a column of storage rack ID 111: a storage location, in a column of storage location 112; an item ID, in a column of item ID 113; a quantity, in a column of quantity 114; a storage start date, in a column of storage start date 115; and a rack position, in a column of rack position 116.

The storage rack ID in the storage rack ID column 111 is an identifier for uniquely identifying the storage rack 3.

The storage location in the storage location column 112 shows a location of a storage space in the storage rack 3, and is indicated by a combination of one of the upper, middle, and lower shelves U, M, and L, and one of the left, the center, and the right storage spaces L, C, and R.

The item ID in the item ID column 113 is an identifier for uniquely identifying (not an individual item but) a kind of an item. To simplify explanation, it is assumed in this embodiment that one storage space stores therein only one kind of one or more items.

The quantity in the quantity column 114 is a quantity of the stored one or more items.

The storage start date in the storage start date column 115 is a date when the items are received at the physical distribution center. To simplify explanation, an item is assumed to be received by a prescribed number of lots. The storage start date used herein is a date when the lot is received.

The rack position in the rack position column 116 is a two-dimensional coordinate value of a square on a floor surface on which the storage rack 3 is presently disposed.

When a storage space stores therein no item, each of the item ID column 113, the quantity column 114, and the storage start date column 115 of a record (a row) of the storage location is blank. Each time an item is received by lot, an item ID, a quantity, and a storage start date of the record are updated. Each time a position at which the storage rack 3 is disposed is changed, a rack position thereof is updated. Each time an item is taken out (picked out), a quantity of the item of interest is updated (reduced). The transport controller 1 acquires information as described above from a terminal device (not illustrated) carried by an operator in charge of item receipt or from the transport vehicle 2; and thereby keeps the storage rack information 32 up to date.

### [Sorting Rack Information]

The sorting rack information 33 is described with reference to FIG. 12. The sorting rack information 33 contains the following in association with a sorting rack ID stored in a column of sorting rack ID 121: a storage location, in a column of storage location 122; an item ID, in a column of item ID 123; a quantity, in a column of quantity 124; a customer name, in a column of customer name 125; a picking area ID in a column of picking area ID 126; and a rack position, in a column of rack position 127.

The sorting rack ID in the sorting rack ID column 121 is an identifier for uniquely identifying the sorting rack 4.

The storage location in the storage location column 122 is a location of a storage space in the sorting rack 4.

The item ID in the item ID column 123 is the same as the item ID in FIG. 11.

The quantity in the quantity column 124 is a quantity of one or more stored ordered items.

The customer name in the customer name column 125 is a name of a customer (who has placed an order for the item of interest).

The picking area ID in the picking area column 126: is an identifier for uniquely identifying the picking area 52; and corresponds to the area ID having the area attribute of “picking area” from among the area IDs in FIG. 10. The sorting rack 4 is transported by the transport vehicle 2 to the picking area 52, at which the picking operator 5 transfers an ordered item to the sorting rack 4.

The rack position in the rack position column 127 is a two-dimensional coordinate value of a square on a floor surface on which the sorting rack 4 is presently disposed.

A record in the sorting rack information 33 is described along the following flow <1> to <8>.

<1> At first, the item ID column 123 to the picking area ID column 126 are blank. The rack position column 127 stores therein, for example, a coordinate value of a prescribed temporary position in the sorting rack transport area 53 at which the sorting rack 4 is disposed.

<2> Upon receipt of an order for an item, the transport controller 1: allocates one of the sorting racks 4 to a customer; and stores a name of the customer in the customer name column 125 of a record of the sorting rack 4.

<3> The transport controller 1: determines the appropriate picking area 52 (to be detailed hereinafter), based on an attribute of the ordered item to be stored in the sorting rack 4; and stores a picking area ID of the determined picking area 52 in the picking area column 126.

<4> The transport controller 1: determines an item ID and a quantity of the ordered item with respect to each storage location (storage space) of the sorting rack 4; fills the item ID column 123 and the quantity column 124 of the record, based on the above-described information; and transmits information on the record to, for example, a terminal device carried by the picking operator 5.

<5> After the transport vehicle 2 transports the sorting rack 4 to a section adjoining the picking area 52 in the sorting rack transport area 53, a rack position of the sorting rack 4 in the record is updated by using a coordinate value of the section adjoining the picking area 52.

<6> Each time the picking operator 5 transfers the item to an appropriate storage space of the sorting rack 4 while viewing the information in the terminal device, the transport controller 1 adds a mark such as a picking completion mark “$” (not illustrated) to data in each of the item ID column 123 and the quantity column 124 of the record, based on data received from the terminal device.

<7> After the transport vehicle 2 transports the sorting rack 4 to the section adjoining the packaging area 54 in the sorting rack transport area 53, the rack position in the record is updated by using a coordinate value of the section adjoining the packaging area 54.

<8> Each time the packaging operator 6 picks an item out of the sorting rack 4 and packages the picked item on a customer by customer basis, the transport controller 1 deletes the data in the item ID column 123 and the quantity column 124 of the record, based on the data received from the terminal device carried by the packaging operator 6.

### [Transport Vehicle Information]

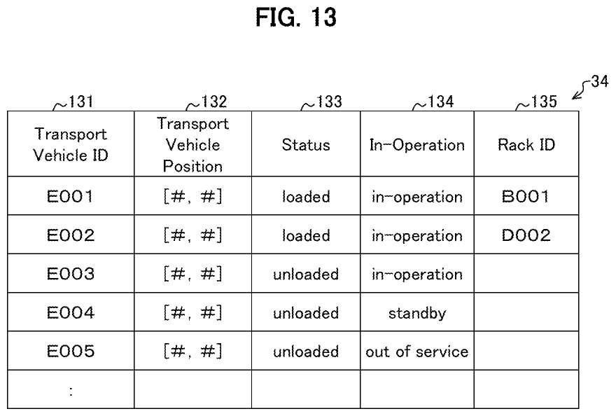

The transport vehicle information 34 is described with reference to FIG. 13. The transport vehicle information 34 contains the following in association with transport vehicle ID stored in a column of transport vehicle ID 131: a transport vehicle position, in a column of transport vehicle position 132; a status, in a column of status flag 133; an in-operation flag, in a column of in-operation 134; and a rack ID, in a column of rack ID 135.

The transport vehicle ID in the transport vehicle ID column 131 is an identifier for uniquely identifying the transport vehicle 2.

The transport vehicle position in the transport vehicle position column 132 is a two-dimensional coordinate value of a square on a floor surface on which the transport vehicle 2 is presently travelling or stopped.

The status flag in the status column 133 is either “loaded” or “unloaded”. “Loaded” indicates that the transport vehicle 2 is presently transporting the storage rack 3 or the sorting rack 4. “Unloaded” indicates that the transport vehicle 2 is not in operation of transporting the storage rack 3 or the sorting rack 4.

The in-operation flag in the in-operation column 134 is one of “in-operation”, “standby”, and “out of service”. “In-operation” indicates that the transport vehicle 2 is in operation of transporting or any other operation pursuant to an instruction received from the transport controller 1. “Standby” indicates that, after completion of the received instruction, the transport vehicle 2 is standing by, waiting for a next instruction. “Out of service” indicates that the transport vehicle 2 is stopped due to occurrence of trouble.

The rack ID in the rack ID column 135 is the same as each of the storage rack ID of FIG. 11 and the sorting rack ID of FIG. 12. The rack ID in the rack ID column 135, however, herein identifies the storage rack 3 or the sorting rack 4 which the transport vehicle 2 is presently transporting.

Each time the transport vehicle 2 passes a boundary line of a square on a floor surface, the transport vehicle position is updated. Each time the transport vehicle 2 lifts the storage rack 3 or the sorting rack 4 up and down, the status flag switches between “loaded” and “unloaded”. The transport controller 1 acquires information as described above from the transport vehicle 2 and thereby keeps the transport vehicle information 34 up to date.

### [Picking Area Information]

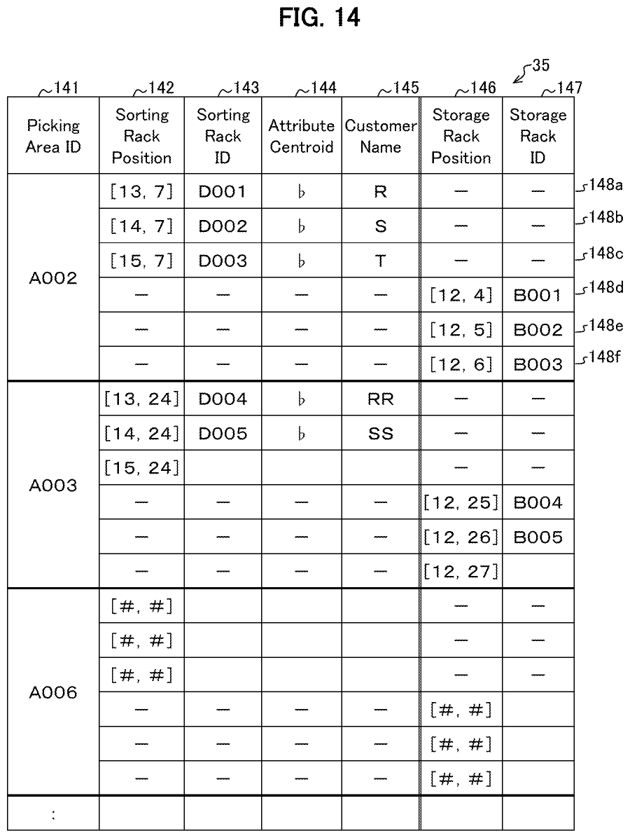

The picking area information 35 is described with reference to FIG. 14. The picking area information 35 contains the following in association with a picking area ID in a column of picking area ID 141: a sorting rack position, in a column of sorting rack position 142; a sorting rack ID, in a column of sorting rack ID 143; an attribute centroid, in a column of attribute centroid 144; a customer name, in a column of customer name 145; a storage rack position, in a column of storage rack position 146; and a storage rack ID, in a column of storage rack ID 147.

The picking area ID in the picking area ID column 141 is same as the picking area ID in FIG. 12.

The sorting rack position in the sorting rack position column 142 is a two-dimensional coordinate of a section adjoining the picking area 52 in the sorting rack transport area 53 and is previously specified as a section in which one or more sorting racks 4 are to be arranged.

The sorting rack ID in the sorting rack ID column 143 is the same as the sorting rack ID of FIG. 12. The sorting rack ID in the sorting rack ID column 143, however, herein identifies the sorting rack 4 which is to be disposed at the sorting rack position.

The attribute centroid in the attribute centroid column 144 will be described later with reference to FIG. 18. In short, the attribute centroid is a scalar quantity or a vector quantity which collectively indicates an attribute of the sorting rack 4, based on an attribute of each of items to be stored in the sorting rack 4. A mark “ [symbol] ” used herein indicates a different scalar or vector quantity in abbreviation.

The customer name in the customer name column 145 is the same as the customer name in FIG. 12.

The storage rack position in the storage rack position column 146 is a two-dimensional coordinate of a section adjoining the picking area 52 in the storage area 51 and which is previously specified as a section in which the storage rack 3 is to be arranged.

The storage rack ID in the storage rack ID column 147 is the same as the storage rack ID in FIG. 11. The storage rack ID in the storage rack ID column 147 especially, however, identifies the storage rack 3 which is to be disposed at the storage rack position.

A mark “-” in the picking area information 35 indicates that no data is present in a column of interest (or the data is indefinable). There is no data about the storage rack 3 in storage rack records 148a to 148c. There is no data about the sorting rack 4 in records 148d to 148f. The records 148a to 148f represent, for example, how the sorting racks 4 and the storage racks 3 are disposed on the left and the right of one of “corners” of the picking area 52 as illustrated in FIG. 5A.

### [Item Information]

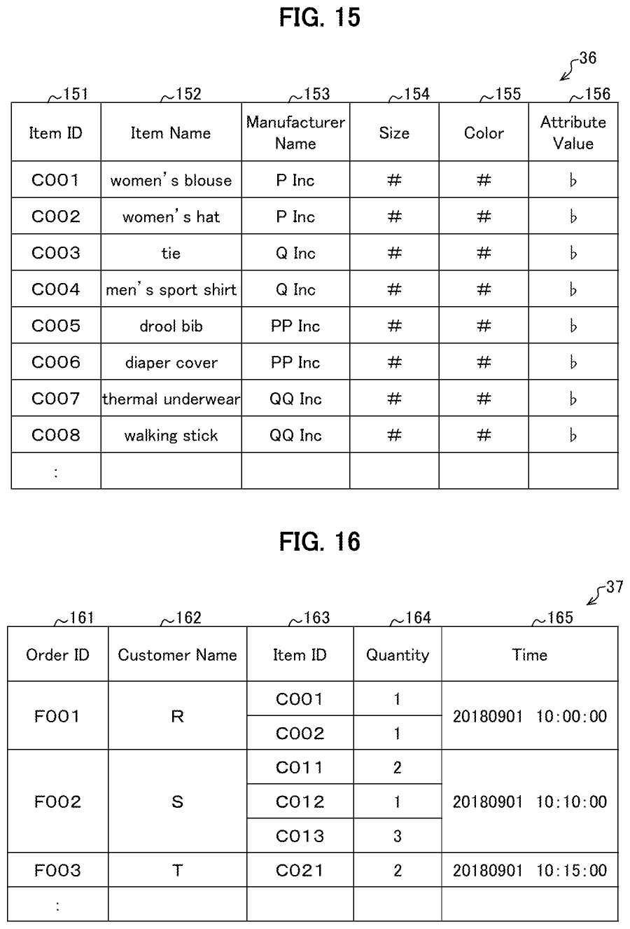

The item information 36 is described with reference to FIG. 15. The item information 36 contains the following in association with an item ID stored in a column of item ID 151: an item name, in a column of item name 152; a manufacturer name, in a column of manufacturer name 153; a size, in a column of size 154, a color, in a column of color 155; and an attribute value, in a column of attribute value 156.

The item ID in the item ID column 151 is the same as the item ID in FIG. 11.

The item name in the item name 152 is a name of a kind of an item.

The manufacturer name in the manufacturer name column 153 is a name of manufacturer which manufactures the item.

The size in the size column 154 is a dimension of an item.

The color in the color column 155 is a color of the item.

The attribute value in the attribute value column 156 will be hereinafter described in detail with reference to FIG. 18. Simply stated, the attribute value is a scalar quantity or a vector quantity indicating an attribute of the item.

The item information 36 illustrated in FIG. 15 is an example in which an item is clothes. Data in each of the columns is freely selected according to a kind of an item, such as a type of a machine part and a production area of groceries. The input device 12 receives such data from a user of the transport controller 1 at an appropriate timing. The transport controller 1 stores the received data in the auxiliary memory 15, as the item information 36.

### [Order Information]

The order information 37 is described with reference to FIG. 16. The order information 37 contains the following in association with an order ID stored in a column of order ID 161: a customer name, in a column of customer name 162; an item ID, in a column of item ID 163; a quantity, in a column of quantity 164; and a time, in a column of time 165.

The order ID in the order ID column 161 is an identifier for uniquely identifying an order from a customer. The order herein means a request for purchase of an item.

The customer name in the customer name column 162 is the same as the customer name in FIG. 12.

The item ID in the item ID column 163 is the same as the item ID in FIG. 11.

The quantity in the quantity column 164 is a quantity of an item ordered.

The time in the time column 165 is a date and time when the transport controller 1 has received the order.

As clearly seen from FIG. 16, a single order contains one or more number of items of one or more kinds. The picking operator 5 transfers one or more items contained in a single order into a single sorting rack 4. Each time an order is received, a new record is created in the order information 37. The transport controller 1: receives such a record from, for example, a server or the like of an operator of an item selling site; and stores the received record in the auxiliary memory 15 as the order information 37.

### [Instruction Information]

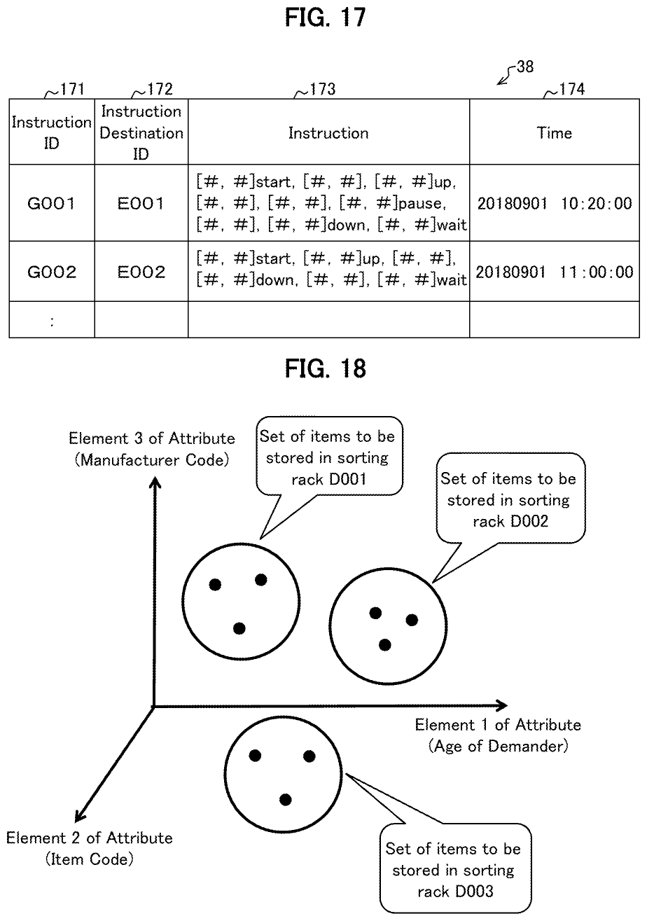

The instruction information 38 is described with reference to FIG. 17. The instruction information 38 contains the following in association with an instruction ID stored in a column of instruction ID 171: an instruction destination ID, in a column of instruction destination ID 172; an instruction, in a column of instruction 173; and, a time, in a column of time 174.

The instruction ID in the instruction ID column 171 is an identifier for uniquely identifying an instruction. The instruction used herein is a direction transmitted from the transport controller 1 to the transport vehicle 2.

The instruction destination ID in the instruction destination ID column 172 is a transport vehicle ID for identifying the transport vehicle 2 which receives an instruction of interest.

The instruction in the instruction column 173 is the instruction described above. Details of the instruction will be described hereinafter.

The time in the time column 174 is a date and time when the transport controller 1 transmits the instruction to the transport vehicle 2.

Description herein is made focusing on a record in the first line of the instruction information 38. The record shows an instruction which the transport controller 1 transmits to the transport vehicle 2 of @“E001”. The instruction is made up of a plurality of “members” which are separated from each other by “,”. Each of the members contains a two-dimensional coordinate value “[#, #]”. Some of the members each contain a character string, in addition to the two-dimensional coordinate value.

The transport vehicle 2 travels on a route which is made up of a plurality of line segments. Each of the line segments is oriented in a longitudinal or a lateral direction of FIG. 1 and cannot be oriented in a diagonal direction. In the member, “[#, #]” represents a square as a node (an angle) of the line segments. The transport vehicle 2 sequentially travels on the node. The character string of “start” indicates a starting point of a given route and is generally a position at which the transport vehicle 2 is standing by. The character string of “wait” indicates an end point of the route and is generally a position at which the transport vehicle 2 is waiting for a next instruction.

“Up” is a position (a rack lift-up point) at which the transport vehicle 2 lifts up the storage rack 3 or the sorting rack 4. “Down” is a position (a rack lift-down point) at which the transport vehicle 2 lifts down the storage rack 3 or the sorting rack 4. “Pause” is a position (an operation point) at which the transport vehicle 2 stands by under the storage rack 3 or the sorting rack 4 while keeping the storage rack 3 or the sorting rack 4 lifted up or down. A picking or a packaging operation is performed at the position. The transport controller 1 may determine a route of the transport vehicle 2. Alternatively, the transport vehicle 2 may do so based on information which is transmitted from the transport controller 1 thereto and shows the storage rack 3 or the sorting rack 4 to be transported.

### [Attribute Value and Attribute Centroid]

An attribute value and an attribute centroid are described with reference to FIG. 18. As explained above referring to FIG. 5A and FIG. 5B, when there are a plurality of the sorting racks 4 into which similar items are to be stored, gathering those sorting racks 4 in one picking area 52 makes an operation more efficient. There are some techniques of defining similarity of items by the sorting rack 4. FIG. 18 illustrates one of such examples. The transport controller 1 represents an attribute of each of all items as a three-dimensional vector. Each of elements of the three-dimensional vector: corresponds to, for example, “Age of Demander”, “Item Code”, and “Manufacturer Code” of an item of interest. A value of the element is normalized so as to fall within a prescribed range.

A given item is illustrated as a point of a “black circle” in a three-dimensional space in which “Age of Demander”, “Item Code”, and “Manufacturer Code” are represented on three axes (FIG. 18). The three-dimensional vector is described above as an example. The vector may have, however, any dimensions. The elements are not limited to the “age of a demander”, “item code”, and “manufacturer code” and may be a price, a production area, an industry type of a demander, or the like. Any elements will do as long as the more similar the items, the shorter a distance therebetween on an axis. For example, when a user recognizes that “a product manufactured by Company A is similar to another product manufactured by Company B, and is not, however, similar to a still another product manufactured by Company C”, the user may set values of elements, for example, such that the values are “Company A=1.0, Company B=1.1, and Company C=2.0” on the axis representing the manufacturer code.

A set of items to be stored in the sorting rack 4 with a number “D001” is a set of items ordered from a given customer. Assume a case in which the set contains “(item ID, quantity)=(C001, 5), (C002, 6), (C003, 4)”. A vector “V_{D001}” indicating an attribute of the sorting rack “D001” is calculated by a formula as follows:

V_{D001}=(5×V_{C001}+6×V_{C002}+4×V_{C003})/(5+6+4)

In the formula, V_{C001} or the like is a vector representing an attribute of the item “C001” or the like. V_{D001} is a weighted average of the vectors representing all of the items to be stored in the sorting rack 4 of interest, which is called an “attribute centroid” (see FIG. 14). Meanwhile, the vector V_{C001} or the like representing the attribute of each of the items is called an attribute value (see FIG. 15). The attribute centroid of the sorting rack 4 can be calculated even when an item is not actually stored in the sorting rack 4.

Based on the calculated attribute centroids for each of the sorting racks 4, the transport controller 1 can create a group of the sorting racks 4 of which attribute centroids are approximate to each other in a multi-dimensional space. The transport controller 1 can also determine which sorting rack 4 belonging to the created group is to be transported to which picking area 52.

In the above-described example, the transport controller 1 creates a group in accordance with a position of the attribute centroid in the multi-dimensional space. The group can be, however, created in a simpler manner. For example, the transport controller 1 determines an item which is the largest in number of all items to be stored in the sorting rack 4; and creates a group of items in which an item code (a one-dimensional scalar quantity) of each of the items is similar to an item code of the determined item. At this time, such item codes may be set as, for example, “women's blouse=1.0, women's hat=1.1, and men's sport shirt=2.0”.

### [Processing Procedure]

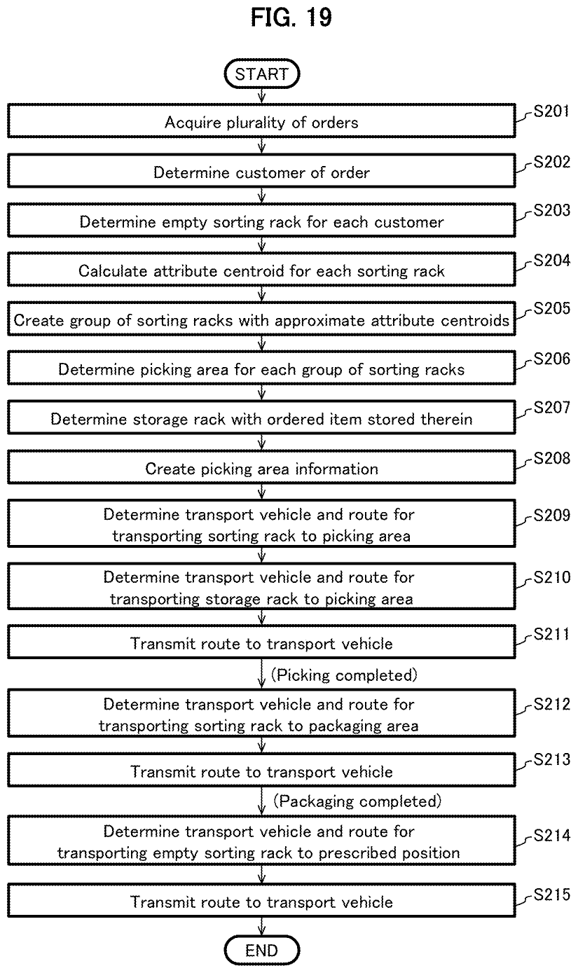

Steps of a processing procedure are described with reference to FIG. 19.

In step S201, the picking preparation part 21 of the transport controller 1 acquires a plurality of orders. More specifically, the picking preparation part 21: constantly monitors how many records of the order information 37 are accumulated; and, in response to the number of the accumulated records reaching a prescribed threshold (for example, “100”), acquires all of the accumulated records.

In step S202, the picking preparation part 21 determines a customer who has placed the order. More specifically, the picking preparation part 21 determines a customer name (100 in total) of the record acquired in step S201, as a customer of the order.

In step S203, the picking preparation part 21 determines the sorting rack 4 which is currently empty, for each of the customers. More specifically, the picking preparation part 21: references the sorting rack information 33 (FIG. 12); and thereby identifies a sorting rack ID for identifying the presently empty sorting rack 4 as much as the number of the customers.

In step S204, the picking preparation part 21 calculates an attribute centroid for each of the sorting racks 4. More specifically, firstly, the picking preparation part 21: references the record acquired in step S201; and acquires an item ID and a quantity of the ordered item for each of the customers, that is, for each of the sorting racks 4.

Secondly, the picking preparation part 21 calculates the attribute centroid for each of the sorting racks 4, based on the item ID and the quantity of the ordered items using the above-described method. Note that the picking preparation part 21: references the item information 36 (FIG. 15); and thereby acquires an attribute value of each item.

In step S205, the picking preparation part 21 creates a group of the sorting racks 4 of which attribute centroids are approximate to each other. More specifically, firstly, the picking preparation part 21 draws respective attribute centroids of 100 units of the sorting racks 4 in a multi-dimensional space.

Secondly, the picking preparation part 21 creates an appropriate number of groups of the sorting racks 4 of which distance between the attribute centroids thereof is close. The “appropriate number” used herein corresponds to the number of the picking areas 52. For example, when there are six picking areas 52 as illustrated in FIG. 3, the 100 sorting racks 4 are divided into six groups, to each of which about 15 to 20 units of the sorting racks may belong, for example.

In step S206, the picking preparation part 21 determines the appropriate picking area 52 for each of the sorting racks 4. Assume a case in which the picking preparation part 21 references the area information 31 (FIG. 10), to thereby acquire six area IDs such as “A002”, “A003”, “A006”, “A007”, “A008”, and “A009” each identified as the area ID of which area attributes are “picking area”. The picking preparation part 21 then allocates the six picking area IDs to the six groups created in step S205 on a one by one basis.

In step S207, the picking preparation part 21 determines the storage rack 4 in which the ordered item has been stored. More specifically, the picking preparation part 21 references the storage rack information 32 (FIG. 11), using the item ID and the quantity of the record acquired in step S201 as a retrieval key; and determines a storage rack ID for identifying the storage rack 4 in which the ordered item has been stored in a required quantity. The picking preparation part 21 repeats this step for each of the records of the order information 37 corresponding to the groups of the sorting rack 4 created as described in the “second” part of step S205. The picking preparation part 21 thus allocates one or more storage rack IDs to each of the picking area IDs. Though the number of the storage rack IDs determined in this step cannot be previously determined, it can be said that the number takes a value of “1” at the smallest.

In step S208, the picking preparation part 21 creates the picking area information 35. More specifically, the picking preparation part 21 creates a record of the picking area information 35 (FIG. 14) for each of the picking area IDs. That is, the picking preparation part 21 stores a picking area ID of the picking area 52 of interest, a sorting rack ID of the sorting rack 4 belonging to a group allocated to the picking area 52, an attribute centroid of the sorting rack 4, and a customer name, in the columns 141 and 143 to 145 of the record, respectively. The picking preparation part 21 also stores the storage rack ID determined in step S207, in the column 147 of the record.

In step S209, the picking preparation part 21 determines the transport vehicle 2 and a route by which the sorting rack 4 is transported to the picking area 52. More specifically, firstly, the picking preparation part 21: references the transport vehicle information 34 (FIG. 13); and determines the transport vehicle 2 that meets, for example, both of the following conditions 11 and 12, for each of the sorting racks 4 determined in step S203. A square in which the transport vehicle 2 that meets the conditions is present becomes a starting point of the route to be described later.

<Condition 11> The transport vehicle 2 to be determined has an in-operation flag of “standby”.

<Condition 12> If a plurality of the transport vehicles 2 each having the in-operation flag “standby” are present, the transport vehicle 2 to be determined has the shortest distance between itself and the sorting rack 4 from among a plurality of the candidate transport vehicles 2.

Secondly, the picking preparation part 21 determines a route that meets, for example, all of the following conditions 21 to 26, for each of the sorting racks 4 determined in step S203.

<Condition 21> The route to be determined has the above-described starting point.

<Condition 22> The route has a prespecified end point at which the transport vehicle 2 stands by.

<Condition 23> On the route, after the transport vehicle 2 becomes loaded, the transport vehicle 2 does not travel on a square on which the storage rack 3 or the sorting rack 4 is disposed.

<Condition 24> The route has a rack lift-up point, an operation point, and a rack lift-down point in this order, between the starting point and the end point. The rack lift-up point used herein is a square on which the sorting rack 4 determined in step S203 is disposed. The operation point used herein is a section adjoining the picking area 52 determined in step S206 in the sorting rack transport area 53. The rack lift-down point is same as the operation point (that is, the transport vehicle 2 lifts down the sorting rack 4 at the operation point and puts the sorting rack 4 in a stable state at the same point).

<Condition 25> The route has the shortest distance between the starting point to the end point thereof, from among a plurality of candidate routes.

<Condition 26> If the route cannot be determined from among the candidates even after examining up to Condition 25, the route to be determined has the smallest number of squares on which the transport vehicle 2 when being unloaded travels under the storage rack 3 or the sorting rack 4.

Thirdly, the picking preparation part 21 creates a record of the instruction information 38 (FIG. 17), based on the determined transport vehicle 2 and route.

In step S210, the picking preparation part 21 determines the transport vehicle 2 and a route by which the storage rack 3 is transported to the picking area 52. More specifically, firstly, the picking preparation part 21: references the transport vehicle information 34 (FIG. 13); and determines the transport vehicle 2 that meets, for example, both of the following conditions 31 and 32, for each of the storage racks 3 determined in step S207. A square in which the transport vehicle 2 that meets the conditions is present becomes a starting point of the route to be described later.

<Condition 31> The transport vehicle 2 to be determined has an in-operation flag of “standby”.

<Condition 32> If a plurality of the transport vehicles 2 in the standby state are present, the transport vehicle 2 to be determined has the shortest distance between itself and the sorting rack 4 is.

Secondly, the picking preparation part 21 determines a route that meets, for example, all of the following conditions 41 to 46, for each of the storage racks 3 determined in step S207.

<Condition 41> The route to be determined has the above-described starting point.

<Condition 42> The route has a prespecified end point at which the transport vehicle 2 stands by.

<Condition 43> On the route, after the transport vehicle 2 becomes loaded, the transport vehicle 2 does not travel on a square on which the storage rack 3 or the sorting rack 4 is disposed.

<Condition 44> The route has a rack lift-up point, an operation point, and a rack lift-down point in this order, between the starting point and the end point. The rack lift-up point used herein is a square on which the storage rack 3 determined in step S207 is disposed. The operation point used herein is, in the storage area 51, a section adjoining the picking area 52 identified by the picking area ID allocated to the storage rack ID in step S207. The rack lift-down point is same as the operation point (that is, the transport vehicle 2 lifts down the storage rack 3 at the operation point and puts the storage rack 3 in a stable state at the same point).

<Condition 45> The route has the shortest distance between the starting point to the end point thereof, from among a plurality of candidate route.

<Condition 46> If the route cannot be determined from among the candidates even after examining up to Condition 45, the route to be determined has the smallest number of squares on which the transport vehicle 2 when being unloaded travels under the storage rack 3 or the sorting rack 4.

Thirdly, the picking preparation part 21 creates a record of the instruction information 38 (FIG. 17), based on the determined transport vehicle 2 and route.

In step S211, the picking preparation part 21 transmits the determined route to the transport vehicle 2. More specifically, firstly, the picking preparation part 21 transmits an instruction containing the route determined as described in the “second” part of step S209, to the transport vehicle 2 determined as described in the “first” part of step S209.

Secondly, the picking preparation part 21 transmits an instruction containing the route determined as described in the “second” part of step S210, to the transport vehicle 2 determined as described in the “first” part of step S210.

The storage racks 3 or the sorting racks 4 are then arranged in each of a plurality of the picking areas 52. It is thus assumed that the picking operator 5 has just completed a picking operation.

In step S212, the packaging preparation part 22 of the transport controller 1 determines the transport vehicle 2 and a route by which the sorting rack 4 is transported to the packaging area 54. Operations in step S212 are similar to those in step S209 except that an operation point of the route in step S212 corresponds to a section adjoining the packaging area 54 in the sorting rack transport area 53.

In step S213, the packaging preparation part 22 transmits the route to the transport vehicle 2. Operations in step S213 are similar to those described in the “first” part of step S211.

The sorting racks 4 each storing therein an ordered item are then arranged in the section adjoining the packaging area 54 in the sorting rack transport area 53. It is thus assumed that the packaging operator 6 has just completed a packaging operation.

In step S214, the packaging preparation part 22 determines the transport vehicle 2 and a route by which the empty sorting rack 4 is transported to a prescribed position. Operations in step S212 are similar to those in step S209, except that the route determined in step S212 does not have an operation point. A rack lift-up point on the route is the section adjoining the packaging area 54 in the sorting rack transport area 53. A rack lift-down point is any position at which a travel of the transport vehicle 2 is not obstructed. The rack lift-down point (a temporary placement position) is in a position that meets, for example, all of the following conditions 51 to 53.

<Condition 51> The position of the rack lift down point is in the sorting rack transport area 53.

<Condition 52> The position is apart from the picking area 52 by a prescribed distance.

<Condition 53> The position is apart from the packaging area 54 by a prescribed distance.

In step S215, the packaging preparation part 22 transmits the route to the transport vehicle 2. Operations in step S215 are similar to those described in the “first” part of step S211. The processing procedure is then terminated.

### [Variation of Steps of Processing Procedure]

Timing at which the processing procedure of FIG. 19 is started is that a prescribed number of orders have been accumulated. This requires that the sorting racks 4 for a large number of customers are divided into groups at one time. The transport controller 1 may, however, divide the sorting racks 4 into groups each time an order is received without waiting until after a prescribed number of orders are accumulated.

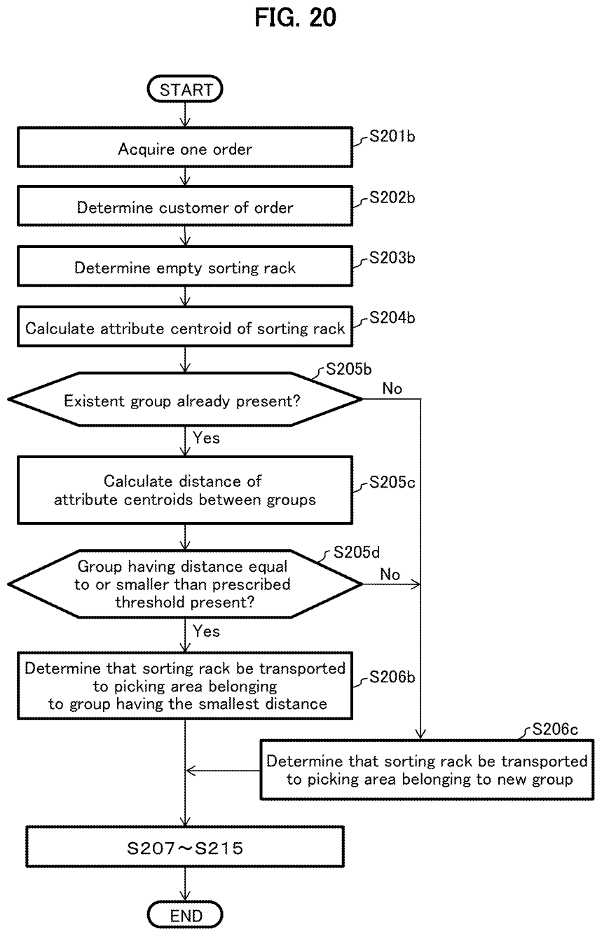

A variation of steps of a processing procedure is described with reference to FIG. 20. Steps S201b, S202b, S206b, and S206c in FIG. 20 are substituted by steps S201 to S206 in FIG. 19.

In step S201b, the picking preparation part 21 of the transport controller 1 receives an order. More specifically, the picking preparation part 21: constantly monitors the order information 37; and, in response to addition of one record to the order information 37, acquires the added record.

In step S202b, the picking preparation part 21 determines a customer who has placed the order. More specifically, the picking preparation part 21 determines a customer name of the record acquired in step S201b as a customer of interest.

In step S203b, the picking preparation part 21 determines the empty sorting rack 4. More specifically, the picking preparation part 21: references the sorting rack information 33 (FIG. 12) and determines one sorting rack ID for identifying the presently empty sorting rack 4.

In step S204b, the picking preparation part 21 calculates an attribute centroid. More specifically, firstly, the picking preparation part 21: references the record acquired in step S201b; and thereby acquires an item ID and a quantity of the ordered item.

Secondly, the picking preparation part 21 calculates an attribute centroid of the sorting rack 4, based on the item ID and the quantity of the ordered item in the above-described manner.

In step S205b, the picking preparation part 21 determines whether or not an existent group has already been present. More specifically, the picking preparation part 21 determines whether or not the sorting rack 4 is disposed at least one of the picking areas 52. If the sorting rack 4 is already disposed at least one of the picking areas 52 (if “Yes” in step S205b), the picking preparation part 21 advances the processing to step S205c. If not (if “No” in step S205b), the picking preparation part 21 advances the processing to step S206c.

In step S205c, the picking preparation part 21 calculates a distance of attribute centroids between different groups. More specifically, firstly, the picking preparation part 21: acquires the attribute centroid of the sorting rack 4 calculated in step S204 (FIG. 19); and calculates an average value of the attribute centroids for each of the groups (the picking areas 52).

Secondly, the picking preparation part 21 calculates a distance between the attribute centroid calculated in step S204b and the attribute centroid calculated as described in the “first” part of step S205c. That is, a distance for each of the sorting racks 4 is calculated.

In step S205d, the picking preparation part 21 determines whether or not a group having the distance equal to or smaller than a prescribed threshold is present. More specifically, if a group having the distance equal to or smaller than the distance calculated as described in the “second” part of step S205c is present (if “Yes” in step S205d), the picking preparation part 21 advances the processing to step S206b. If not (if “No” in step S205d), the picking preparation part 21 advances the processing to step S206c.

In step S206b, the picking preparation part 21 determines that the sorting rack 4 be transported to the picking area 52 belonging to the group having the smallest distance. Herein assume a case in which, for example, the item ordered in step S201b is groceries. In this case, in the picking area 52 to which one or more sorting racks 4 for the customer “convenience store A” or the like are transported, the sorting rack 4 determined in step S203b is transported to the tail end of the one or more already-arranged sorting racks 4 (see the sorting rack 4d in FIG. 5A).

In step S206c, the picking preparation part 21 determines that the sorting rack 4 be transported to the picking area 52 belonging to a new group. Assume a case in which, for example, the item ordered in step S201b is neither groceries nor clothes. In this case, in a picking area to which one or more sorting racks 4 for a customer of “convenience store A” or the like are transported, the sorting rack 4 determined in step S203b is transported to the picking area 52 in which no other sorting rack 4 is present.

The picking preparation part 21 then advances the processing to steps S207 to S215 (FIG. 19).

### [Kind and Quantity of Item and the Number of Sorting Rack]

In the above-described explanation, a single unit of the sorting rack 4 is basically made to correspond to a single customer of interest. The following exceptional cases are, however, also possible.

<Exceptional case 1: Customer with item at small quantity> Assume a case in which, for example, one customer places an order for an item of one kind, and so does another customer. If the basic approach is used, a movement line of the picking operator 5 may disadvantageously become longer. In that case, the transport controller 1 makes one sorting rack 4 correspond to up to nine customers. If the transport controller 1 determines that a plurality of items which are otherwise basically to be stored in a plurality of the sorting racks 4 each belonging to a given same group can be stored in the same single sorting rack 4, the transport controller 1 then takes an individual storage space in the single sorting rack 4 as a “virtual sorting rack”. For example, an attribute of a customer (a convenience store, a candy store, a clothing store, a department store, or the like) is known, the transport controller 1 may allocate a plurality of customers whose attributes are similar to each other, to the single sorting rack 4. The auxiliary memory 15 may previously store therein a group of customers whose attributes are similar to each other.

<Exceptional case 2: customer with item at large quantity> Assume a case in which, for example, one customer places an order for an item at a large quantity (for example, a large truckload of the item). Obviously, the basic approach cannot be used. In that case, the transport controller 1 makes a plurality of the sorting racks 4 correspond to a single customer. If the transport controller 1 determines that an item ordered by a customer which is otherwise basically to be stored in the same single sorting rack 4 cannot be stored therein, the transport controller 1 then takes a plurality of the sorting racks 4 as a block of the “virtual sorting rack”.

### ADVANTAGEOUS EFFECTS IN EMBODIMENT

Advantageous effects of the transport system 1 and others in this embodiment are as follows.

(1) The transport system 1 can reduce load of the picking operator 5.

(2) The transport system 1 can gather operations of picking similar items in the single picking area 52.

(3) The transport system 1 calculates a weighted average of multi-dimensional vectors representing attributes of items, and thus, can accurately determine a group to which the sorting rack 4 is to belong.

(4) The transport system 1 can reduce load of the packaging operator 6.

(5) The transport system 1 can temporarily place the empty sorting rack 4 in a safe position.

(6) The layout of physical distribution can arrange the picking area 52 and the packaging area 54 adjoining each other and can thereby improve efficiency of entire operation.

The present invention is carried out not only by the above-described embodiment but also by variations of many types. For example, the above-described embodiment is intended to be illustrative of the present invention in an easily understandable manner and the present invention is not limited to the one that includes all of the components explained in the embodiment. Part of a configuration of an example of the present invention can be substituted by or added to that of another example. Part of a configuration of an example can be deleted.

### DESCRIPTION OF REFERENCE NUMERALS

1 transport controller
2 transport vehicle (transport robot)
3 storage rack (storage container)
4 sorting rack (sorting container)
5 picking operator
6 packaging operator
11 central control unit
12 input device
13 output device
14 main memory
15 auxiliary memory
16 communication device
21 picking preparation part
22 packaging preparation part
31 area information
32 storage rack information
33 sorting rack information
34 transport vehicle information
35 picking area information
36 item information
37 order information
38 instruction information
51 storage area
52 picking area
53 sorting rack transport area
54 packaging area

1. A transport system, comprising:
a storage container that stores therein an item before the item is subjected to an order picking operation;
a sorting container that stores therein an item after the item is subjected to the order picking operation;
a transport robot that holds the storage container or the sorting container and transports the storage container or the sorting container in the holding state; and
a transport controller configured to transmit, to the transport robot, an instruction that the storage container or the sorting container be transported to a picking area in which an item for which an order is placed from a customer is picked from the storage container and is transferred to the sorting container, and, in determining which customer for an ordered item be allocated to which sorting container, allocate one customer to one sorting container.

2. A transport system, comprising:
a storage container that stores therein an item before the item is subjected to an order picking operation;
a sorting container that stores therein an item after the item is subjected to the order picking operation;
a transport robot that holds the storage container or the sorting container and transports the storage container or the sorting container in the holding state; and
a transport controller configured to transmit, to the transport robot, an instruction that the storage container or the sorting container be transported to a picking area in which an item for which an order is placed from a customer is picked from the storage container and is transferred to the sorting container, and, in determining which customer for an ordered item be allocated to which sorting container, allocate one customer to one sorting container or allocate a plurality of customers having respective attributes thereof similar to each other, to one sorting container.

3. The transport system according to claim 1,
wherein the transport controller is configured to:
determine one picking area to which the sorting container is to be transported, from among a plurality of candidate picking areas, based on an attribute of an item stored in the sorting container; and
transmit an instruction that the sorting container be transported to the determined picking area, to the transport robot.

4. The transport system according to claim 1,
wherein the transport controller is configured to: divide a plurality of the sorting containers into a plurality of groups, based on an attribute of an item stored in each of the sorting containers; and determine, for each of the groups, a picking area to which the sorting container is to be transported.

5. The transport system according to claim 1,
wherein the transport controller is configured to divide items stored in the sorting container into groups such that items having attributes similar to each other belong to the same group.

6. The transport system according to claim 1,
wherein the transport controller is configured to: represent an attribute of each of the items stored in the sorting container, using a multi-dimensional vector; calculate a weighted average of the represented multi-dimensional vectors as an attribute of the sorting container; and divide a plurality of the sorting containers into a plurality of groups, based on the calculated attribute.

7. The transport system according to claim 1,
wherein the transport controller is configured to transmit an instruction that the sorting container be transported from the picking area to the packaging area in which the item is packaged for each of the customers, to the transport robot.

8. The transport system according to claim 7,
wherein the transport controller is configured to transmit an instruction that the sorting container with no item stored therein be transported to a position at which a travel of the transport robot is not obstructed, to the transport robot.

9. A transport controller: that is communicably connected to a transport robot that holds a storage container which stores therein an item before the item is subjected to an order picking operation, or a sorting container which stores therein an item after the item is subjected to the order picking operation, and transports the storage container or the sorting container in the holding state; that is configured to transmit, to the transport robot, an instruction that the storage container or the sorting container be transported to a picking area in which an item for which an order is placed from a customer is picked from the storage container and is transferred to the sorting container; and, in determining which customer for an ordered item be allocated to which sorting container, that is configured to allocate one customer to one sorting container.

10. A layout of physical distribution, comprising:
a plurality of picking area in each of which a storage container which stores therein an item before the item is subjected to an order picking operation, and a sorting container which stores therein an item after the item is subjected to the order picking operation gather together, and in which an item for which an order is placed from a customer is picked from the storage container and is transferred to the sorting container for each customer; and
a packaging area in which the item for the order is picked from the sorting container and is packaged for each of the customers,
wherein the packaging area is disposed between a plurality of the picking areas.

11. The transport system according to claim 2,
wherein the transport controller is configured to:
determine one picking area to which the sorting container is to be transported, from among a plurality of candidate picking areas, based on an attribute of an item stored in the sorting container; and
transmit an instruction that the sorting container be transported to the determined picking area, to the transport robot.

12. The transport system according to claim 2,
wherein the transport controller is configured to: divide a plurality of the sorting containers into a plurality of groups, based on an attribute of an item stored in each of the sorting containers; and determine, for each of the groups, a picking area to which the sorting container is to be transported.

13. The transport system according to claim 2,
wherein the transport controller is configured to divide items stored in the sorting container into groups such that items having attributes similar to each other belong to the same group.

14. The transport system according to claim 2,
wherein the transport controller is configured to: represent an attribute of each of the items stored in the sorting container, using a multi-dimensional vector; calculate a weighted average of the represented multi-dimensional vectors as an attribute of the sorting container; and divide a plurality of the sorting containers into a plurality of groups, based on the calculated attribute.

15. The transport system according claim 2,
wherein the transport controller is configured to transmit an instruction that the sorting container be transported from the picking area to the packaging area in which the item is packaged for each of the customers, to the transport robot.

16. The transport system according to claim 15,
wherein the transport controller is configured to transmit an instruction that the sorting container with no item stored therein be transported to a position at which a travel of the transport robot is not obstructed, to the transport robot.
